(19) United States
(12) Patent Application Publication
(10) Pub. No.: US 2026/0038004 A1
(43) Pub. Date: Feb. 5, 2026

(54) METHOD AND SYSTEM FOR CAMPAIGN PACING

(71) Applicant: GUPSHUP TECHNOLOGY INDIA PRIVATE LIMITED, Maharashtra (IN)

(72) Inventor: Nirmesh MEHTA, Maharashtra (IN)

(21) Appl. No.: 19/307,317

(22) Filed: Aug. 22, 2025

(30) Foreign Application Priority Data
Aug. 23, 2024 (IN) 20241063954

(51) Int. Cl. G06Q 30/0251; G06Q 30/0242

(52) U.S. Cl. CPC G06Q 30/0264; G06Q 30/0244

(57) ABSTRACT

The present invention discloses a method (300) and a system (100) for campaign pacing. The method (300) comprises receiving campaign data from a first device. The campaign data comprises information associated with a plurality of target users and a campaign message associated with a product. Further, the method (300) comprises analyzing the campaign message using an artificial intelligence technique. Upon analysis, the method (300) comprises determining a priority of the campaign message and a pacing rate of sending the campaign message based on the analysis of the campaign message. The method (300) further comprises transmitting the campaign message to a plurality of user devices (102, 202) associated with the plurality of target users based on the determined pacing rate via a communication channel (204).

### CROSS REFERENCE TO RELATED APPLICATION AND PRIORITY

The present invention claims priority from Indian Patent Application number 202421063954 filed on date 23 Aug. 2024.

### FIELD OF THE INVENTION

The present subject matter described herein, in general, relates to a method and system for campaign pacing. The present invention relates to the field of messaging campaign pacing. More particularly, the invention relates to campaign pacing with minimal integration.

### BACKGROUND OF THE INVENTION

In the present digital era, businesses and marketers extensively utilize messaging campaigns as an effective medium for promoting and selling a variety of products and services. In such campaigns, multiple messages related to a particular product or promotional activity are transmitted to a large number of users. These users may, in turn, respond to the messages, thereby generating interaction data that requires further handling. Typically, once a response is received from a user, an agent is assigned to engage with the user and provide relevant assistance or information pertaining to the campaign.

However, existing systems for managing such campaigns suffer from significant drawbacks. A key challenge arises when there is an uneven inflow of user responses, particularly at times when a limited number of agents are available to handle them, and an imbalance occurs in traffic distribution. In such situations, some users may experience delays in receiving assistance, or in certain cases, may not receive any support at all. This lack of timely response can cause user dissatisfaction, leading to disengagement from the campaign and, consequently, a decline in potential conversions or sales. Further, users may abandon participation in the campaign, or decide against purchasing the promoted products, thereby reducing the overall effectiveness of the campaign.

### OBJECTS OF THE INVENTION

Main object of the present disclosure is to provide a method to integrate a campaign pacing platform with an agent dashboard with minimal integration.

Another object of the present disclosure is to analyze a message feed associated with user-agent conversations using one of a Natural Language Processing (NLP) technique and a machine learning technique.

Yet another object of the present disclosure is to determine a set of agents getting overloaded based on delays in response times.

Another object of the present disclosure is to infer agent availability and modulate send-rate without deep, bespoke integrations such as a practical shim for pacing deployable quickly.

Yet another object of the present disclosure is to determine patterns regarding time lagged responses to campaigns.

Another object of the present disclosure is to determine a rate of messages to be sent to a plurality of users in a campaign based on analysis of real-time data and historical data using an artificial intelligence technique.

Yet another object of the present disclosure is to tune a campaign response and an agent workload for a closed-loop optimization.

Another object of the present disclosure is to predict a number of messages to be sent to ensure best utilization of the agents without significant degradation in a user experience.

Yet another object of the present disclosure is to dynamically balance message distribution across multiple agents in real-time to minimize idle time and maximize campaign efficiency.

Another object of the present disclosure is to enable predictive allocation of agents to incoming user responses using machine learning models.

Yet another object of the present disclosure is to provide a flexible and modular pacing platform that can be easily integrated with third-party campaign management and customer relationship management (CRM) tools.

Another object of the present disclosure is to provide initiate a campaign using a pacing module.

Yet another object of the present disclosure is to determine a pacing rate of sending a campaign message to the plurality of users.

Another object of the present disclosure is to use an artificial intelligence model to analyze message data and historical data.

### SUMMARY OF THE INVENTION

Before the present campaign pacing with minimal integration is described, it is to be understood that this application is not limited to a particular a method and a system for campaign pacing as there may be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to a method and a system for campaign pacing. This summary is not intended to identify essential features of the claimed subject matter nor is it intended for use in determining or limiting the scope of the claimed subject matter.

The present invention discloses a method for campaign pacing. The method comprises receiving, by a processor, campaign data from a first device. The campaign data comprises information associated with a plurality of target users and a campaign message associated with a product. Further, the campaign message is queued using a queue scheduling technique. The method further comprises analyzing, by the processor, the campaign message using an artificial intelligence technique. The artificial intelligence technique uses a training data model trained using historical data associated with multiple campaigns of the product of multiple products. The method further comprises determining, by the processor, a priority of the campaign message and a pacing rate of sending the campaign message based on the analysis of the campaign message. Further, the method comprises transmitting, by the processor, the campaign message to a plurality of user devices associated with the plurality of target users based on the determined pacing rate via a communication channel.

The present invention discloses a campaign pacing system. The system comprises a memory and a processor. In the embodiment, the processor is configured to execute the instructions stored in the memory. In one embodiment, the processor is configured to receive campaign data from a first device. Further, the campaign data comprises information associated with a plurality of target users and a campaign message associated with a product. The campaign message is further queued using a queue scheduling technique. The processor is further configured to analyze the campaign message using an artificial intelligence technique. Further, the artificial intelligence technique uses a training data model trained using historical data associated with multiple campaigns of multiple products. Further, the processor is configured to determine a priority of the campaign message and a pacing rate of sending the campaign message based on the analysis of the campaign message. Further, the processor is configured to transmit the campaign message to a plurality of user devices associated with the plurality of target users based on the determined pacing rate via a communication channel.

The present invention discloses a computer program product for campaign pacing. The computer program product comprising a non-transitory computer-readable storage medium having stored thereon instructions that are executed by one or more processors. Further, the one or more processors are configured to receive campaign data from a first device. The campaign data comprises information associated with a plurality of target users and a campaign message associated with a product. The campaign message is further queued using a queue scheduling technique. Further, the one or more processors are configured to analyze the campaign message using an artificial intelligence technique. The artificial intelligence technique uses a training data model trained using historical data associated with multiple campaigns of multiple products. Furthermore, the one or more processors are configured to determine a priority of the campaign message and a pacing rate of sending the campaign message based on the analysis of the campaign message. The one or more processors are further configured to transmit the campaign message to a plurality of user devices associated with the plurality of target users based on the determined pacing rate via a communication channel.

### STATEMENT OF INVENTION

In one embodiment, the historical data comprises a user behavior, an agent behavior, historical response data associated with the users, a historical response rate, and data associated with different campaign initiated in a defined time period.

In one embodiment, the pacing rate is determined based on a number of agents available to assist the users and agent availability and information associated with an average response times, a response quality, and resolution rates associated with each of a plurality of agents.

In one embodiment, the priority of the campaign message is determined based on user engagement trends identified from the historical data.

In one embodiment, the communication channel is one of a Short Message Service (SMS), an email, a mobile application, and a web-based notification.

In one embodiment, the method further comprises receiving, by the processor, one or more user responses, associated with the campaign message, from one or more of the plurality of user devices. Further, the method comprises transmitting, by the processor, the one or more user responses to one or more agent device of a plurality of agent devices in real-time. The one or more agent devices are selected based on a working status of each agent device. The working status comprises at least one of an active status, an idle status, a busy status, and an offline status.

In one embodiment, the method further comprises enabling, by the processor, a direct communication, in real-time, between the one or more agent devices and one or more user devices corresponding to the one or more user responses.

In one embodiment, the method further comprises analyzing, by the processor, the one or more user responses, in real-time, based on the campaign message and the historical data, using the training data model, to dynamically update the pacing rate for ongoing or future campaigns.

In one embodiment, a campaign pacing system is configured to receive the campaign data from a Communications Platform as a Service (CPaaS) provider module and transmit the campaign message to the communication channel with minimal integration for campaign pacing.

### BRIEF DESCRIPTION OF DRAWINGS

The foregoing summary, as well as the following detailed description of embodiments, is better understood when read in conjunction with the appended drawings. For the purpose of illustrating the disclosure, there is shown in the present document example constructions of the disclosure. The detailed description is described with reference to the following accompanying figures.

FIG. 1(a) illustrates a block diagram of a network implementation of a system for campaign pacing, in accordance with an embodiment of the present subject matter.

FIG. 1(b) illustrates a block diagram of the campaign pacing system, in accordance with an embodiment of the present subject matter.

FIG. 2 illustrates a campaign pacing system in a preferred embodiment of the present invention.

FIG. 3 illustrates a flow chart diagram for a method for campaign pacing, in accordance with an embodiment of the present subject matter.

The figure depicts various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words are not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, system, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Currently, messaging campaigns have become a widely adopted tool for businesses and marketers to promote and sell products or services. Such campaigns typically involve sending multiple messages relating to a campaign to a large group of users and subsequently receiving responses from one or more of these users. Once a response is received, a human agent is generally assigned to interact with the user and provide campaign-related assistance or product information.

Conventional systems, however, face notable limitations in managing the flow of user responses. In particular, when multiple users respond simultaneously and the available agents are already engaged, an imbalance occurs in traffic distribution. This often leads to long wait times or inadequate support for users. Consequently, users may lose interest, abandon participation in the campaign, or decide against purchasing the promoted products, thereby reducing the overall effectiveness of the campaign.

Accordingly, there exists a need for an improved campaign pacing system that addresses these drawbacks by managing uneven response traffic, optimizing agent availability, and ensuring timely user engagement. Such a system would enhance the efficiency of campaign operations, improve user satisfaction, and ultimately increase campaign success rates.

In an existing system, a campaign tool receives a file related to a campaign from a marketer. The file comprises a list of target users. Further, the campaign tool sends a marketing message related to the campaign to each user from the list of target users via a Communications Platform as a Service (CPaaS) platform module. In one embodiment, the CPaaS platform module is configured to provide various services like control governance, disaggregation, and the like. The CPaaS platform module is further configured to forward the marketing message to a communication channel. The communication channel is further configured to send the marketing message to a user device associated with each user. Further, the communication channel may receive a response associated with the marketing message from the user device. Furthermore, the communication channel sends the response from each of the user device associated with each user from the plurality of users to an agent dashboard via the CPaaS platform module. Further, the agent dashboard identifies an agent from a plurality of agents who can communicate with a user.

Once the agent is identified, the response, associated with the marketing message, received from the user device is shared with the agent. The agent may further communicate with the user. However, it may happen that the agents are busy when the responses from the users are received. Thus, the agents may not be able to communicate properly with the users. In such case, the user may lose an interest of participating in the campaign as the user is not getting proper assistance from the agent.

In one embodiment, an integration of a campaign pacing platform with an agent dashboard may be required to solve the problem in the existing system. However, the integration of the campaign pacing platform and the agent dashboard is a time consuming and difficult task. Further, the present invention provides an embodiment for minimal integration of the campaign pacing platform and the agent dashboard to allow a campaign to be paced as per agent availability.

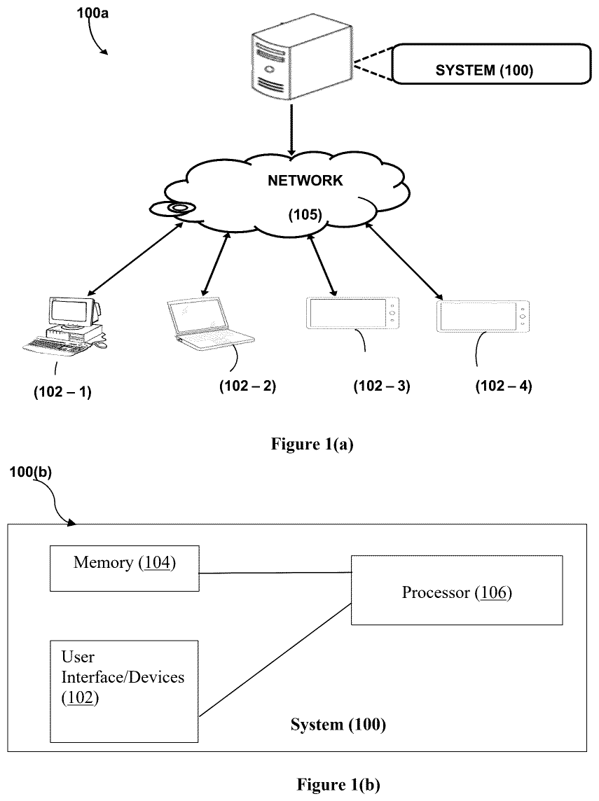

Referring now to FIG. 1(a), a network implementation (100a) of a system (100) for campaign pacing is illustrated, in accordance with an embodiment of the present subject matter.

Although the present disclosure may be explained considering that the system (100) may be implemented on the server, it may be understood that the system (100) may be implemented in a variety of computing systems, such as a laptop computer, a desktop computer, a notebook, a workstation, a mainframe computer, a server, a network server, a cloud-based computing environment. It will be understood that the system (100) may be accessed by multiple users through one or more user devices (102-1), (102-2) . . . (102-N), collectively referred to as user 102, hereinafter, or applications residing on the user devices (102). In an embodiment, the user devices (102) may be a mobile device, a web, a computer device, a laptop, and the like.

In one implementation, the system (100) may comprise the cloud-based computing environment in which a user may operate individual computing systems configured to execute remotely located applications. Examples of the user devices (102) may include, but are not limited to, an IoT device, IoT gateway, portable computer, a personal digital assistant, a handheld device, and a workstation. The user devices (102) are communicatively coupled to the system (100) through a network (105). Further, the user device (102) may be used by a user to examine the messages transmitted using the campaign spacing system. In one embodiment, the user may be a marketer person, a target user, an agent, and the like.

In one implementation, the network (105) may be a wireless network, a wired network or a combination thereof. The network (105) can be implemented as one of the different types of networks, such as intranet, local area network (LAN), wide area network (WAN), the internet, and the like. The network (105) may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network (105) may include a variety of network devices, including routers, bridges, servers, computing devices, storage devices, and the like.

In one aspect, the intent may indicate a context of receiving campaign data from a first device. The campaign data comprises information associated with a plurality of target users and a campaign message associated with a product. The campaign message is further queued using a queue scheduling technique. The system (100) may be further configured to analyze the campaign message using an artificial intelligence technique. The artificial intelligence technique uses a training data model trained using historical data associated with multiple campaigns of multiple products. The system (100) may be further configured to determine a priority of the campaign message and a pacing rate of sending the campaign message based on the analysis of the campaign message. The system (100) may be further configured to transmit the campaign message to a plurality of user devices (102) associated with the plurality of target users based on the determined pacing rate via a communication channel.

In accordance with an embodiment, FIG. 1(b) illustrates a block diagram (100b) of the system for campaign pacing, in accordance with an embodiment of the present subject matter.

The system (100) comprises a user interface (102), a memory (104), and processor (106). The memory (104) stores a plurality of instructions to be executed by the processor (106).

Referring now to FIG. 1(b), the system (100) is illustrated in accordance with an embodiment of the present subject matter. In one embodiment, the system (100) may include, a user interface/devices (102), a memory (104), and at least one processor (106). The at least one processor (106) may be implemented as one or more microprocessors, microcomputers, microcontrollers, digital signal processors, central processing units, state machines, logic circuitries, and/or any devices that manipulate signals based on operational instructions. Among other capabilities, the at least one processor (106) is configured to fetch and execute computer-readable instructions stored in the memory (104).

In one embodiment, during operation, the system (100) may be configured to receive campaign data from a first device. The campaign data may comprise information associated with a plurality of target users and a campaign message associated with a product or a service. In one embodiment, the first device may be referred to as a marketer device used by a marketer. The marketer may provide an input using the first device to initiate the campaign. Upon receiving inputs from the first device, the system (100) may receive the campaign data from the marketer.

In one embodiment, the campaign data may include information identifying the plurality of target users such as user identifiers, device addresses, demographic attributes, or behavioral data, the campaign message comprising one or more of text, images, audio, video, or interactive media, and metadata defining campaign constraints such as budget, campaign duration, offers or discount data, regulatory restrictions, and delivery preferences.

Upon receiving, the system (100) may be configured to insert the campaign message into a queue using a queue scheduling technique. In one embodiment, the campaign message may be inserted into a delivery queue that is managed by the processor (106). The queue may ensure orderly handling of multiple campaign messages originating from the same campaign or from different concurrent campaigns. The queue scheduling technique may dictate the order and timing at which messages are released to the communication channel. In one embodiment, the queue scheduling techniques may include, but not limited to, priority queues, weighted round robin, time-slot allocation, and adaptive load balancing queues.

Further, the system (100) may be configured to analyze the campaign message using an artificial intelligence technique. The artificial intelligence technique may be configured to use a training data model. The training data model may be trained using historical data associated with multiple campaigns of multiple products or services. The historical data may comprise a user behavior, an agent behavior, historical response data associated with the users, a historical response rate, and data associated with different campaign initiated in a defined time period.

In one embodiment, the training data model may be trained based on: historical campaign performance metrics such as open rates, click-through rates, conversions, and user engagement; contextual parameters including time-of-day, geographic region, seasonal variation, and channel type; product-category-specific behavior patterns; and prior pacing rates and delivery sequences that led to optimal outcomes.

In one embodiment, the AI technique may be configured to use natural language processing (NLP) for analysis of the campaign message to extract sentiment, intent, and relevance. The system (100) may predict whether the campaign message is likely to be perceived as positive, neutral, or negative by the target audience. Additionally, topic modeling techniques may be applied to identify dominant themes within the campaign message and compare them with themes historically associated with successful campaigns.

In one embodiment, the training data model may be a Machine Leaning (ML) model. The ML model may include supervised, unsupervised, or reinforcement learning techniques, depending on the type of campaign data being processed. The training data model may be trained using historical datasets of prior campaigns, enabling it to identify correlations between message characteristics and observed user responses. The training phase of the training data model may involve ingestion of a large corpus of campaign performance records. Each record may include: the message content, the channel used for transmission, time of delivery, geographic and demographic attributes of the recipients, and resulting user interactions such as click-through rate, conversion rate, or unsubscribe rate. The training data model may extract feature vectors from these records and uses the feature vectors to learn patterns that are predictive of future campaign success. In one example, the model may learn that promotional offers containing percentage discounts generate higher engagement when sent in the evening hours, whereas informational updates yield better performance in the morning.

When the campaign message includes visual or multimedia content, the analysis may incorporate computer vision techniques. In an embodiment, the AI technique may use image analysis to evaluate engagement potential of visual content. In one example, convolutional neural networks (CNNs) may be used to evaluate images embedded in the campaign message. The system (100) may detect the presence of product images, logos, or emotional expressions in the content and assign an engagement likelihood score based on historical performance of visually similar content. Similarly, if the campaign message includes video or audio, feature extraction techniques such as spectrogram analysis or deep learning-based video frame analysis may be used to assess impact.

In some embodiments, the system (100) may apply contextual correlation analysis between message attributes and external conditions. In one example, if the historical dataset indicates that user engagement with travel-related campaigns increases during holiday seasons, the training data model can infer that a current campaign about travel should be prioritized and delivered at a higher pacing rate during similar time windows. The training data model may further continuously adapt campaign pacing decisions to align with predicted engagement levels.

In an embodiment, the system (100) may utilize a reinforcement learning technique. The reinforcement learning technique may include continuously optimizing pacing strategy or pacing rate based on real-time feedback from campaign execution. In one example, if early deliveries of the campaign message show unexpectedly low engagement, the system (100) dynamically reduces the pacing rate or reallocates bandwidth to another campaign predicted to yield higher returns. Conversely, if real-time responses exceed expectations, the system (100) may accelerate delivery by reprioritizing queued messages.

Based on the analysis of the campaign message, the system (100) may be configured to determine a priority of the campaign message and a pacing rate of sending the campaign message. The priority of the campaign message may be indicative of an urgency of delivery, likelihood of high engagement, or business-defined criticality. In one embodiment, the priority of a campaign message may be calculated as a weighted score derived from multiple AI outputs, such as: an engagement probability, an urgency factor, business defined criticality, and contextual conditions. The engagement probability may indicate the likelihood that users will interact with the campaign message e.g., open, click, or convert. Further, the urgency factor may indicate whether the campaign message is tied to time-sensitive events such as flash sales, product launches, or compliance deadlines. The business-defined criticality may indicate advertiser- or system-defined rules that elevate certain campaign types e.g., financial alerts over marketing promotions. The contextual conditions may comprise a time of day, a region, or user segment responsiveness, derived from historical campaign behavior. Further, the resulting priority score may be normalized e.g., on a scale of 0 to 1 or ranked across all queued messages, and mapped to scheduling classes such as “high,” “medium,” or “low.”

In one embodiment, the priority of the campaign message may be determined based on user engagement trends identified from the historical data. The system (100) may analyze prior user interactions such as open rates, click-through rates, dwell times, and conversions to detect patterns in how users have historically engaged with similar types of content. The campaign message that align with periods of historically high engagement—for instance, product promotions sent during weekends or festive seasons—may be assigned higher priority scores. Further, the campaign message resembling content that previously showed low engagement may be deprioritized, ensuring that system resources are directed toward campaigns with greater likelihood of success.

In some embodiments, the historical data may be segmented by user attributes, communication channels, and temporal factors, allowing the AI model to identify granular engagement trends. In one embodiment, younger demographics may respond more actively to push notifications in evening hours, while professional audiences may show higher engagement with email campaigns during weekday mornings. By leveraging such trends, the system (100) can assign a higher priority to the campaign message expected to trigger favorable user responses, while reducing the priority of campaigns that are predicted to underperform. The system (100) may ensure that priority determination is data-driven and adaptive, thereby improving overall campaign effectiveness.

Once a priority is determined, the system (100) may determine the pacing rate for transmitting the campaign message. The pacing rate of sending the campaign message may indicate a number of messages per unit time, adaptive throttling based on channel availability, or dynamic adjustment in response to real-time feedback. The pacing rate may be determined in real-time for each campaign message in the campaign. The pacing rate may be determined based on a number of agents available to assist the users and information associated with an average response times, a response quality, and resolution rates associated with each of a plurality of agents. The agents may assisting users in response to the campaign. In one embodiment, when the campaign involves two-way interactions such as users replying to the campaign message to request information, initiate a purchase, or resolve a query, the system may need to ensure that adequate agent resources are available to handle incoming responses without creating delays or degrading user experience.

In the embodiment, the system (100) may analyze agent availability metrics, including a total number of agents currently active, logged in, or capable of responding to user interactions. The system (100) may evaluate average response times associated with each agent, thereby identifying whether the existing workforce can sustain high pacing rates or if pacing must be reduced to avoid overwhelming the agents.

In an aspect, the pacing rate determination may include response quality metrics. In an embodiment, the system (100) may track historical conversation records to determine how effectively each agent resolved prior queries. The metrics such as customer satisfaction ratings, accuracy of responses, or escalation frequency may be quantified to produce a response quality score. The higher response quality may justify maintaining or increasing pacing rates, while lower quality may necessitate pacing reductions to ensure that users still receive satisfactory assistance.

In one embodiment, the pacing rate may be determined based on resolution rates of agents. The resolution rate may indicate a proportion of user queries that are fully addressed, by the agents, without requiring multiple follow-ups or escalations. In an aspect, a higher aggregate resolution rate across the active agents indicates a greater capacity to handle incoming responses efficiently, allowing the system (100) to maintain or even accelerate the pacing rate. Further, if resolution rates are low, the system (100) may lower the pacing rate to prevent the accumulation of unresolved cases.

In one example, if 50 agents are available, each with an average response time of under 30 seconds and historical resolution rates above 85%, the system may safely assign a high pacing rate, such as releasing 5,000 campaign messages per minute. However, if only 10 agents are available, with response times exceeding one minute and resolution rates below 60%, the pacing rate may be throttled to 500 messages per minute or deferred to staggered time slots.

The system (100) may be dynamically adjusting pacing based on the agent availability and the performance metrics, to ensure that campaign delivery remains aligned with service capacity. The system (100) may be configured to prevent scenarios in which users respond in large volumes but cannot be promptly assisted, thereby improving overall system efficiency, customer satisfaction, and campaign effectiveness.

In one embodiment, high-priority messages may be assigned faster pacing rates, with greater bandwidth allocation and earlier time slots. Further, medium-priority messages may be delivered at moderate pacing rates, balanced with other concurrent campaigns. Furthermore, low-priority messages may be throttled, deferred to non-peak hours, or even rescheduled for secondary channels.

In one example, if the system (100) predicts a high engagement probability for a campaign announcing a limited-time discount, the system (100) may assign it the highest priority and set a pacing rate of 10,000 messages per minute during the next 30 minutes. Further, if a routine newsletter is predicted to have lower engagement, it may be queued with a pacing rate of 500 messages per minute, distributed evenly over several hours to avoid overloading the system (100).

In one example, messages predicted to have high engagement probability may be assigned higher priority and a faster pacing rate. Conversely, lower priority messages may be delivered more slowly or during off-peak times to optimize resource utilization.

Further, the system (100) may transmit the campaign message to a plurality of user devices (102) associated with the plurality of target users based on the determined pacing rate via a communication channel. The campaign message may be transmitted to the plurality of user devices when multiple agents are available simultaneously to assist the plurality of target users without delay. The communication channel may be one of a Short Message Service (SMS), an email, a mobile application, and a web-based notification.

In one embodiment, the system (100) track information, associated with each agent from a plurality of agents, comprising a login status, workload levels, and real-time responsiveness of agents. When the system (100) detects that an adequate number of agents are online and capable of providing timely support to the plurality of users, the campaign messages are transmitted at the determined pacing rate. The system (100) ensures that users who respond to the campaign message receive prompt assistance, thereby preventing bottlenecks or service delays.

In one aspect, the information of each agent of the plurality of agents may be stored at an agent dashboard. The agent dashboard may be communicatively coupled to the system (100). The agent dashboard may further comprise agent data comprising demographic agent details, workload, working status, and the like. Each agent of the plurality of agents may be using an agent device from a plurality of agent devices.

In another embodiment, the system (100) may dynamically synchronize the pacing rate with agent workforce fluctuations. In one example, if a large number of agents are active during business hours, the pacing rate may be increased to allow mass transmission of campaign messages. Further, if the number of available agents drops during off-peak hours, the pacing rate may be throttled or transmission deferred until sufficient agent resources are restored. The transmission strategy may be adaptive and resource-aware, balancing campaign effectiveness with service quality.

Further, the system (100) may be configured to receive one or more user responses, associated with the campaign message, from one or more of the plurality of user devices (102). The system (100) may receive the one or more user responses associated with the campaign message from one or more of the plurality of user devices (102) via the communication channel. The user responses may include text replies, voice inputs, button selections, or any other form of digital interaction indicating user interest, queries, or feedback.

The system (100) may further transmit the one or more user responses to one or more agent device of the plurality of agent devices in real-time. The one or more agent devices may be selected based on the working status of each agent device. The working status comprises at least one of: an active status, an idle status, a busy status, and an offline status. The active status may indicate that agent currently handling a conversation, the idle status may indicate the agent logged in and available for assignment, the busy status may indicate that agent engaged with multiple users and near capacity, and the offline status may indicate that agent not logged in or unavailable.

In one embodiment, based on the working status information, the system (100) may automatically select an appropriate agent device to receive the user response. In one example, if an agent device is identified as idle, the system (100) may immediately route the user response to that agent device. If multiple idle agents are available, the system (100) may further apply a load-balancing algorithm, such as round-robin assignment, weighted distribution based on skill level, or priority-based routing. Further, if all agents are busy, the system (100) may either queue the user responses temporarily or transmit the user responses to an automated response module until a human agent becomes available.

Upon transmitting the user responses to the agent devices, the system (100) may be configured to initiate a direct communication, in real-time, between the one or more agent devices and one or more user devices (102) corresponding to the one or more user responses. The users and the agents may communicate using the communication channel. In one aspect, the communication session, between the selected one or more agent devices and the one or more user devices may be facilitated through the same communication channel as the campaign message (e.g., SMS, push notification, email) or through an alternative channel such as live chat, in-app messaging, or voice-over-IP (VOIP). The direct communication allows the agent to engage with the user immediately, addressing questions, providing personalized responses, or completing transactions without delay.

In one embodiments, the system (100) may further log the communication session and update the historical campaign dataset with the user's response patterns and agent interaction outcomes. The logged data may be subsequently utilized by the training data model to refine future campaign pacing, priority assignments, and routing strategies. The system (100) ensures that user responses are not only handled efficiently but also contribute to continuous learning and optimization of campaign delivery.

Further, the system (100) may analyse the one or more user responses, in real-time, based on the campaign message and the historical data, using the training data model. The training data model may use supervised, unsupervised, or reinforcement learning techniques to analyse the one or more user responses. The training data model may incorporate prior user behavior patterns, agent performance metrics, and campaign outcomes to produce predictive insights on user engagement and campaign effectiveness.

Based on the analysis, the system (100) may be configured to dynamically update the pacing rate for either ongoing campaigns or future campaigns. In one example, if the campaign message generates a higher-than-expected volume of positive responses within a short time frame, the pacing rate may be automatically increased to accelerate message delivery to the remaining target users. In the example, if user responses indicate disengagement, negative sentiment, or low conversion likelihood, the pacing rate may be reduced to minimize unnecessary system load and prevent user fatigue.

In one embodiment, the pacing rate adjustment may occur within the same campaign execution cycle. In an aspect, during an active campaign sending 10,000 messages per hour, if the system detects high click-through rates from the first 2,000 recipients, the system may increase throughput to 20,000 messages per hour for the remaining users. In another embodiment, the pacing rate updates may be applied to future campaigns, where insights from prior response analysis are incorporated into the AI model to inform pacing decisions for subsequent product launches or promotional events.

In one embodiments, the analysis of the one or more user responses may include natural language processing (NLP) of free-text replies to detect sentiment, intent, or urgency. In one example, if responses contain positive keywords such as “interested,” “sign me up,” or “buy now,” the system (100) may classify the responses as high-engagement signals and accelerate pacing. Further, if negative sentiment is detected (e.g., “stop,” “not interested,” or “unsubscribe”), the system may slow or pause pacing to reduce churn.

In another embodiment, the analysis of the one or more user responses may include response metadata evaluation, such as response time i.e., a speed of reply after receiving the message, response channel preference, or demographic segmentation. Further, faster response times may indicate high user interest and may trigger an increase in pacing rate, while delayed responses may result in conservative pacing. Furthermore, if a particular demographic shows strong responsiveness, the system may prioritize pacing toward that segment while throttling other segments.

The system (100) may further incorporate multi-agent availability into the dynamic update process. The system (100) may compare the number of agent availability with a threshold number. In one example, if user responses spike during the campaign, but the number of available agents is below the threshold number, the pacing rate may be held steady or decreased to prevent service bottlenecks. Once additional agents become active, the pacing rate may be increased dynamically. The system (100) may ensure that high response volumes are matched with sufficient support capacity.

In another embodiment, the system (100) may utilize the reinforcement learning technique, where the pacing strategy may be continuously refined based on real-time rewards and penalties. In one example, if accelerating the pacing rate yields higher conversions, the AI model reinforces this decision. If pacing acceleration results in high unsubscribe rates or agent overload, the AI model penalizes the decision and reduces pacing in subsequent iterations.

In one exemplary embodiment, assume a campaign advertising a flash sale. During the first ten minutes, the system detects that 15% of recipients reply with “Interested” or click the provided purchase link. Upon recognizing this as a strong positive engagement signal, the system increases pacing from 5,000 to 12,000 messages per minute to maximize sale participation before inventory is depleted. Alternatively, if recipients reply with “Too expensive” or “Not relevant,” the system slows pacing to 1,000 messages per minute and reallocates delivery slots to another ongoing campaign with higher predicted success.

The system (100) ensures that pacing is not static but data-driven, context-aware, and continuously optimized. The system (100) may enable campaigns to achieve higher efficiency, minimize wasted delivery, and improve overall user experience.

In one embodiment, the system (100) may receive the campaign data from a Communications Platform as a Service (CPaaS) provider module (206) and transmit the campaign message to the communication channel (204) with minimal integration for campaign pacing. Further, the system (100) may use minimal integration between the campaign pacing platform and the agent dashboard to allow the campaign to be paced as per agent availability to quickly finishing campaigns without causing long user wait times. Further, the system (100) can be used with the CPaaS provider module and an already existing agent dashboard or queue with minimal integration and without any significant, difficult integration. Further, the pacing module may be included with the CPaaS provider module and the agent dashboard to infer agent availability and modulate send-rate without deep, bespoke integrations such as a practical shim for pacing deployable quickly.

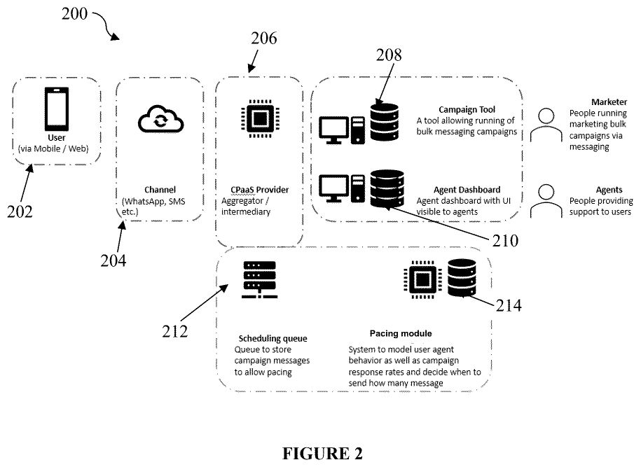

Referring to FIG. 2, an exemplary embodiment (200) of the campaign pacing system (100) is illustrated, in accordance with an embodiment of the present invention. In one embodiment, the campaign pacing system (100) may comprise a user device (202), a communication channel (204), a Communications Platform as a Service (CPaaS) provider module (206), a campaign tool (208), an agent dashboard (210), a queue scheduler (212), and a pacing module (214). In one embodiment, the pacing module (214), along with the queue scheduler (212), may be integrated with the agent dashboard (210) and the campaign tool (208).

In one embodiment, the user device (202) may be a mobile device, a web, a computer device, a laptop, and the like. The user device (202) may be associated with a user. In one example, each user from a plurality of target users may be using the user device (202).

Further, the communication channel (204) may be a platform used for communication by the user and an agent. The communication channel (204) may be one of a WhatsApp platform, an email, a messaging platform, a Short Message Service (SMS), and the like. In one example, the communication channel (204) may correspond to an application downloaded on the user device (202) by the user.

The CPaaS provider module (206) may be a cloud-based platform that provides businesses with Application Programming Interfaces (APIs) for integrating real-time communication features like SMS, voice calls, video chat, and the like, into their applications. The CPaaS provider module (206) may further provide various services such as control governance, disaggregation, strict compliance and privacy regulations, such as healthcare, education, or finance, and the like.

The CPaaS provider module (206) may further be configured to provide a plurality of control and governance services that manage how campaign messages are delivered across diverse communication channels (204). Such governance may include policy enforcement, traffic shaping, and prioritization of specific campaign types based on contractual obligations, regulatory restrictions, or service-level agreements. The CPaaS provider module (206) may perform disaggregation of communication flows, such that the campaign traffic is separated into distinct logical or physical channels to ensure reliable performance, prevent congestion, and enable granular monitoring of each campaign or user segment.

In one embodiments, the CPaaS provider module (206) may ensure strict compliance with privacy and regulatory frameworks applicable to sensitive industries such as healthcare, education, finance, and government. In one example, the CPaaS provider module (206) may incorporate mechanisms for encryption, secure key management, data residency enforcement, and anonymization of personally identifiable information. In healthcare campaigns, the CPaaS provider module (206) may enforce HIPAA-compliant message handling; in education, FERPA-compliant safeguards; and in finance, compliance with PCI-DSS or similar standards. By embedding such compliance and privacy controls, the CPaaS provider module (206) guarantees that the campaign messages are transmitted in accordance with industry-specific legal requirements while maintaining trust, data integrity, and end-user confidentiality.

Further, the campaign tool (208) may allow running of bulk message campaigns. In an aspect, a plurality of campaign messages may be prepared, queued, and transmitted to a large number of target users in parallel. The campaign tool (208) may be used for sending messages to the plurality of target users at the same time. In one example, the campaign tool (208) may run a campaign by sending campaign messages to the plurality of target users. The campaign tool (208) may be handled by the marketer device used by a marketer. The marketer may correspond to a group of people running bulk campaign marketing via messaging.

The campaign tool (208) may use queue scheduling techniques and pacing control mechanisms. The campaign tool (208) may ensure that even when multiple campaigns are being executed in parallel, delivery of bulk messages is managed without overwhelming network resources or agent availability.

In one embodiment, the campaign tool (208) may provide a marketer-facing interface accessible via the marketer device. The marketer device may correspond to a computing device such as a desktop, laptop, tablet, or smartphone used by an individual or a team of individuals responsible for managing campaign activities. Through the marketer device, the marketer may configure bulk campaigns by selecting target user segments, defining campaign objectives, scheduling delivery times, and composing campaign messages. The marketer may also monitor campaign performance in real-time, including open rates, click-through rates, and response patterns, and may dynamically adjust campaign parameters during execution.

Further, the marketer may represent not just a single individual but a group of people or an organizational team collaborating through the campaign tool to design, launch, and monitor campaigns. In one example, a marketing department within a retail enterprise may run seasonal sales campaigns to millions of customers simultaneously, while a healthcare provider may send bulk compliance reminders e.g., vaccination updates, to patients. In financial services, the campaign tool (208) may be utilized to broadcast regulatory updates or fraud alerts to customers at scale, ensuring rapid dissemination of critical information.

Furthermore, the agent dashboard (210) may be connecting the plurality of agents to the plurality of target users. The agent dashboard (210) may comprise a user interface that is visible to each of the plurality of agents. Each agent from the plurality of agents may access the agent dashboard (210) using an agent device (not shown). The agent device may be one of a mobile device, a computer system, a laptop, and the like. In one embodiment, the agent dashboard (210) may allow each agent to view messages received from multiple users simultaneously and to select specific user interactions for response.

The agent dashboard (210) may provide contextual assistance features to improve the quality and efficiency of agent interactions. For example, the dashboard may display recommended responses generated by an AI-based suggestion engine, historical interactions with the same user, or product-specific knowledge base articles. Each agent from the plurality of agents may provide assistance to one or more users, where the assistance may be associated with the campaign itself (e.g., clarifying promotional offers) or with a product of the campaign (e.g., answering technical support questions). The agent dashboard (210) may further include collaboration features that allow multiple agents to jointly resolve complex user issues, thereby ensuring faster and more accurate response handling.

In one embodiment, the queue scheduler (212) may be referred to as scheduling queue platform (212). The queue scheduler (212) may be configured to temporarily store the campaign messages in a queue to facilitate pacing and orderly transmission. The queue scheduler (212) may operate as a buffer between the campaign tool (208) and the communication channels (204), ensuring that large-scale campaigns are executed without exceeding network or agent capacity. The queue scheduler (212) may organize the campaign message based on various scheduling techniques, including priority-based queues, round-robin scheduling, weighted allocation, or adaptive load balancing.

The queue scheduler (212) may also be configured to receive inputs from the pacing module that may determine the optimal rate and order of transmission. Based on these inputs, the queue scheduler (212) may dynamically reorder the queued messages, throttle delivery rates, or pause/resume campaigns in response to system load, agent availability, or compliance constraints. In one example, if the pacing module (214) determines that only a limited number of agents are available at a given time, the queue scheduler (212) may hold lower-priority campaign messages in the queue until more resources become available. In another embodiment, the queue scheduler (212) may support multi-tenant scheduling, where the camping messages from different campaigns or organizations are stored in separate queucs but still managed under a unified scheduling platform.

Further, the pacing module (214) may be configured to analyze message data associated with user-agent conversation using an artificial intelligence (AI) technique. In one embodiment, the artificial intelligence (AI) technique may corresponds to a Natural Language Processing (NLP) technique. In one embodiment, the pacing module (214) may analyze the message data using a machine learning technique. Further, the pacing module (214) may analyze data associated with a user behavior, an agent behavior, historical response data associated with the users, a historical response rate, and the like using the artificial intelligence technique. The data may be associated with different campaign initiated in a defined time period. Further, the artificial intelligence (AI) technique may uses a training data model. The training data model may be trained using historical data associated with multiple campaigns of multiple products. The historical data may comprises a user behavior, an agent behavior, historical response data associated with the users, a historical response rate, and data associated with different campaign initiated in a defined time period.

In one embodiment, the pacing module (214) may use the artificial intelligence technique to analyze the data. Based on the analysis of the message data and the data, the pacing module (214) may be configured to determine a campaign pacing rate. The campaign pacing rate may indicate a rate associated with sending the campaign messages to the plurality of users. The campaign pacing rate may indicate when to send how many messages to the plurality of users so that the plurality of agents are free to provide assistance to the plurality of user for the campaign. In one embodiment, the pacing module (214) may determine a time at which the campaign messages are sent to the plurality of users. In the embodiment, the time may indicate a period when multiple agents are free and are able to support the plurality of users in a campaign process to avoid any prolong delays. Further, the pacing rate may be determined based on a number of agents available to assist the users and information associated with an average response times, a response quality, and resolution rates associated with each of the plurality of agents.

In one embodiment, the pacing module (214) may determine a particular time at which the campaign messages are sent to the plurality of users, and a time at which the user may respond. In one embodiment, one campaign process may observe a uniform response rate from the plurality of users for a period of time. Further, the campaign process may observe no response rate from the plurality of users after the period of time. In another embodiment, another campaign process may observe an initial response rate such as 10% from the plurality of users for a time period such as 1 hour, and further the response rate may decreases by half for every hour.

Further, the pacing module (214) may use the artificial intelligence technique to generate and use a plurality of user level parameters. The plurality of user level parameters may include a responsiveness profile, a day-part affinity vector, an agent-needed probability, a prior conversation length, a use-case propensity, a channel and language preference, a recency or frequency or monetary signals, a compliance guardrails. The responsiveness profile may configured to be a probability of replying within a time period. Further, the time period may be 5 mins, 1 hrs, 6 hrs, 24 hrs, or 72 hrs with a p50/p95 response latency. Further, the day-part affinity vector may determine the relative likelihood of replying in each hour block. The day-part affinity vector may correspond to the captures work vs. leisure patterns. Further, the agent-needed probability may analyze the chance that one user may require a real-time conversation with one agent. Further, the prior conversation length may determine the expected handling-time distribution when an agent is needed. Further, the use-case propensity may determine the probabilities over detected intents such as an info request, a purchase, a KYC, a reschedule, and such the alike. Further, the channel and language preference may determine the weights that affect both the response latency and need for an agent intervention. Further, the recency or frequency or monetary signals may improve a conversion-weighted pacing. Further, the compliance guardrails may flags to mask certain send windows such as a do-not-disturb hours, and a consent status.

In one embodiment, the pacing rates and campaign priorities may be determined using a multi-stage learning process that begins with segment-level priors derived from historical campaign data. In one example, initial probability distributions may be constructed for user engagement metrics such as open rate, click-through rate, or conversion rate, based on aggregated outcomes of past campaigns targeted to similar audience segments. These priors may be used as a baseline expectation for new campaign messages when no real-time data is yet available. As live campaign interactions are received, the system may refine these priors on a per-user or per-segment basis using techniques such as Bayesian updating or regularized maximum likelihood estimation (MLE). The system (100) may allow to progressively adapt its pacing rate and message prioritization strategies as new user response data becomes available.

In an embodiment, where data for a particular user or micro-segment is sparse or insufficient, the system (100) may implement a back-off strategy that reverts to broader cohort-level priors to maintain stability in predictions and avoid overfitting. In one example, if a single user has not yet interacted with multiple campaign messages, the system (100) may rely on cohort-level behavior e.g., users of similar demographics, geographies, or purchasing histories, to determine appropriate pacing rates and delivery timings. The hierarchical learning approach ensures robustness by balancing individualized adaptation with reliable historical patterns. By integrating these statistical learning methods with NLP- and ML-based analysis of the campaign message content, the system (100) may dynamically optimize both when and how fast messages are sent, thereby maximizing engagement while minimizing wasted delivery attempts.

Further, the pacing module (214) may use the AI technique to determine the close relation between one or more historical campaigns from a plurality of campaigns to a current campaign. In one embodiment, the AI technique may use the historical data with statistical methods to generate parameters suited for the current campaign. Further, the AI technique with the historical data and user-level parameters may estimate response rate of the number of users and the time period.

In one embodiment, the pacing module (214) may determine the degree of similarity or closeness between one or more historical campaigns from a plurality of past campaigns and the current campaign being executed using the AI technique. The determination of closeness may be based on multiple attributes, including, but not limited, to campaign message type, product category, user demographics, delivery channel, and seasonal or contextual factors. By applying similarity detection methods such as clustering, cosine similarity, or embedding-based vector analysis, the pacing module (214) may identify historical campaigns that exhibit comparable engagement patterns to the current campaign. The identified similarity enables the system to transfer learned pacing strategies, such as optimal delivery intervals or throttling rates, from past campaigns to the current one, thereby reducing the need for trial-and-error during early execution stages.

Further, the pacing module (214) may integrate the identified historical data with statistical and predictive modeling techniques to generate parameters suited for the current campaign. In one example, regression analysis, Bayesian inference, or probabilistic graphical models may be applied to user-level and segment-level parameters to estimate expected engagement outcomes. Such parameters may include the predicted response rate of users and the anticipated time period within which responses are likely to occur. The pacing module (214) may, not only adapts delivery speed and priority dynamically, but also ensures that campaigns are executed in alignment with empirically validated patterns of user behavior. By combining similarity-based learning with statistical estimation, the system (100) ensures more precise pacing control and higher overall efficiency in campaign management.

In one embodiment, during operation, the campaign tool (208) may receive an input from the marketer device to initiate a campaign. In an embodiment, the campaign tool (208) may receive campaign data from the marketer device. The campaign data may be referred to as a file comprising a list of target users for the campaign and a campaign message. The list of target user may correspond to the plurality of users. The campaign message may include details related to the campaign and a product associated with the campaign. In one embodiment, the campaign tool (208) may be accessed by the marketer via the first device such as a mobile phone, a laptop, a computer system, a tablet, and the like.

Further, the CPaaS provider module (206) may be configured to receive the campaign message from the campaign tool (208). In one embodiment, the CPaaS provider module (206) may provide various services like control governance, disaggregation, and the like. Furthermore, the queue scheduler (212) may be connected to the CPaaS provider module (206). The queue scheduler (212) may be configured to keep the campaign message in a queue.

Simultaneously, the pacing module (214) may be configured to analyze the campaign message, agent behavior, historical data such as previous user behavior, previous campaign pacing rate, previous user-agent behavior, an agent behavior, and the like using the artificial intelligence technique. In one example, the pacing module (214) may use the artificial intelligence model to analyze the historical data, and the NLP technique to analyze the campaign message. Based on the analysis, the pacing module (214) may determine a priority of the campaign message.

In one embodiment, the pacing module (214) may determine the pacing rate at which the campaign message is to be sent to the plurality of users. In one embodiment, the pacing module (214) may determine the time to initiate the campaign so that multiple agents are free and are able to assist the plurality of users, when the response from each of the plurality of users is received. Further, the pacing module (214) may direct the queue scheduler (212) to keep the campaign message in a queue based on the priority and the pacing rate of the campaign message.

Further, the queue scheduler (212) may be configured to send the campaign message to the communication channel (204) at the time determined by the pacing module (214). Further, the communication channel (204) may further send the campaign message to the plurality of user device (202) associated with the plurality of users. In one embodiment, each user from the plurality of users may read or access the campaign message received via the communication channel (204) using the user device (202).

Further, the user may generate a response associated with the campaign message using the user device (202). The response may be a text message, a video message, an audio message and the like. The user device (202) may be configured to send the response associated with the campaign message to the communication channel (204). The communication channel (204) may be further configured to send the response to the CPaaS provider module (206). In one embodiment, the user device (202) may send the response to the CPaaS provider module (206) via the communication channel (204).

In one embodiment, the pacing module (214) may receive the response associated with the campaign message from the CPaaS provider module (206). In one embodiment, the CPaaS provider module (206) may receive the response from one or more users from the plurality of users using the plurality of user devices (202). Further, the pacing module (214) may analyze the response from each user, the campaign message, and the historical data associated with the user and the agents. The pacing module (214) may use the artificial intelligence model to analyze the response, the campaign message, and the historical data. The artificial intelligence model further improve an accuracy to determine the time associated with sending the campaign messages to the plurality of users such that multiple agents from the plurality of agents are free to assist the plurality of users upon receiving the response from the plurality of users.

Once the response is received, the CPaaS provider module (206) may send the response associated with each user to the agent dashboard (210). The agent dashboard (210) may further identify an agent from the plurality of agents who is free and are able to assist one of the plurality of users. In one embodiment, the agent dashboard (210) may identify the agent by analyzing a working status of each of the plurality of agents. The working status of the agent may be one of busy, present, absent, and the like. In one embodiment, the agent dashboard (210) may allocate the agent to one of the plurality of users.

Further, the agent dashboard (210) may further send the response received from the user to the agent. The agent may access the response from the user using the agent dashboard (210). The agent may further directly communicate with the user, and provides assistance to the user. In one embodiment, the agent may help the user in the campaign process. In another embodiment, the agent may assist the user in a buying process of the product associated with the campaign. The agent may use the agent device to communicate with the user using the user device (202).

Further, the agent dashboard (210) may use historical data associated with user-agent conversation to determine a conversation time period, a historic waiting time, a historic response latency, a historic traffic and the alike. The agent dashboard (210) may use the AI technique to determine which users may only want more information and may complete a transaction outside of chat while other users may want information and then complete the transaction in the chat itself.

In one embodiment, the agent dashboard (210) may use the artificial intelligence (AI) technique to analyze incoming user responses and behavioral signals in real-time in order to determine the intent and likely transactional path of each user. The AI technique may employ natural language processing (NLP) to extract sentiment, intent, and context from textual chat interactions, as well as machine learning models trained on historical user interaction data. In one example, the AI may identify linguistic cues, engagement frequency, or message length to predict whether the user is primarily seeking additional product information, general guidance, or clarification prior to making a decision. Based on the analysis, the system may classify users into categories such as “information-seeking only,” where the user is expected to complete the transaction through an external channel (e.g., website or offline purchase), or “chat-based transactional,” where the user is likely to proceed with the transaction within the chat interface itself.

Further, the agent dashboard (210) may adapt routing logic based on the classifications to optimize agent resources and user experience. In one example, the users predicted to complete the transaction outside of the chat may be provided with concise and structured information, links to external resources, or automated knowledge-based responses, thereby minimizing agent intervention. Further, the users identified as likely to transact within the chat may be prioritized for live agent engagement, with the system surfacing personalized offers, product configurations, or payment gateways directly within the chat interface. By dynamically distinguishing between these two classes of users, the agent dashboard (210) enables more efficient allocation of agent workload while simultaneously improving conversion rates and user satisfaction across campaign interactions.

In one embodiment, the pacing module (214) may modulate the pacing rate via a minimal-integration pacing control implemented at the Communications Platform as a Service (CPaaS)-side queue. Further, the pacing control may operates adjacent to the CPaaS platform module (204) and the agent dashboard (210) to infer the agent availability and adjust the pacing rate without deep, bespoke integrations. Further, the minimal-integration pacing control may act as a practical shim to make pacing deployable quickly and hassle free. The minimal-integration pacing control may operate in close association with the CPaaS platform module (204) and the agent dashboard (210) to infer agent availability without requiring deep or bespoke integrations into existing systems. The configuration allows the pacing module (214) to act as a lightweight shim layer that can be deployed quickly and without major disruption to legacy systems. In one example, the pacing module (214) may monitor traffic levels and agent status exposed through standard APIs or log streams, and based on such information, adjust the message transmission rate in real-time. The system (100) ensures a practical and scalable pacing mechanism while reducing deployment complexity.

Further, the pacing module (214) may execute a dual-model, real-time closed-loop control system to dynamically regulate campaign throughput while ensuring user experience quality. The dual-model system may include a campaign model and an agent model, which function in tandem. The campaign model may be trained to predict time-lagged user responses based on factors such as the send time of the campaign message, historical response distributions, and contextual variables (e.g., day of week or channel type). In parallel, the agent model may predict conversation length and queue wait-time distributions for ongoing and future interactions. Both models may continuously update their parameters based on live interaction data, thereby enabling the pacing module (214) to anticipate demand on agent resources and proactively modulate the pacing rate.

In one example, in a healthcare-related campaign where appointment reminders are sent to patients, the campaign model may predict that messages sent in the morning generate faster and higher response rates compared to evening messages. Simultaneously, the agent model may predict that average conversation durations in the morning are shorter but that wait-times increase when agent staffing is low. Based on the combination of these parameters in a closed-loop manner, the pacing module (214) may reduce the message pacing rate during periods of low staffing to avoid long wait-times, and conversely, increase pacing when more agents are available, thereby maximizing throughput while maintaining acceptable response quality. The dual-model design ensures that the system not only reacts to real-time agent conditions but also proactively manages user interactions based on predictive analytics, thereby providing both scalability and responsiveness across different campaign scenarios.

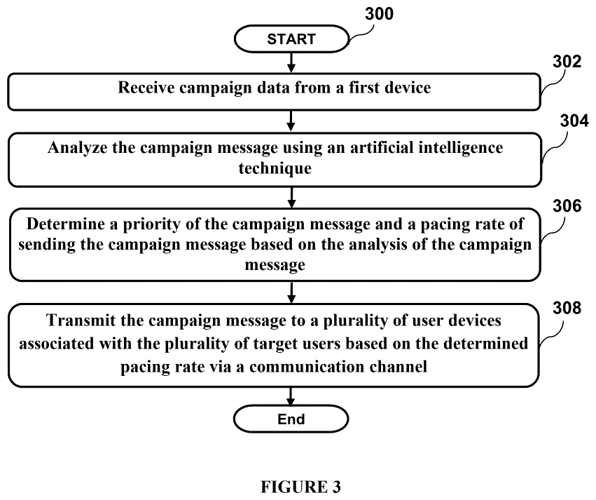

FIG. 3 illustrates a flow chart performing a method (300) for campaign pacing, in accordance with an embodiment of the present subject matter. The order in which the method (300) is described is not intended to be construed as a limitation, and any number of the described method blocks may be combined in any order to implement the method (300) or alternate methods. Additionally, individual blocks may be deleted from the method (300) without departing from the spirit and scope of the subject matter described herein. Furthermore, the method may be implemented in any suitable hardware, software, firmware, or combination thereof. However, for case of explanation, in the embodiments described below, the method (300) may be considered to be implemented as described in the system (100).

At block (302), campaign data may be received from a first device. In one embodiment, the campaign data may comprise information associated with a plurality of target users and a campaign message associated with a product. The campaign message may be further queued using a queue scheduling technique.

At block (304), the campaign message may be analyzed using an artificial intelligence technique. In one embodiment, the artificial intelligence technique may use a training data model trained using historical data associated with multiple campaigns of multiple products. The historical data may comprise a user behavior, an agent behavior, historical response data associated with the users, a historical response rate, and data associated with different campaign initiated in a defined time period.

At block (306), a priority of the campaign message and a pacing rate of sending the campaign message may be determined based on the analysis of the campaign message. The pacing rate may be determined based on a number of agents available to assist the users and information associated with an average response times, a response quality, and resolution rates associated with each of a plurality of agents. The priority of the campaign message may be determined based on user engagement trends identified from the historical data.

At block (308), the campaign message may be transmitted to a plurality of user devices associated with the plurality of target users based on the determined pacing rate via a communication channel (204). The communication channel (204) may be one of a Short Message Service (SMS), an email, a mobile application, and a web-based notification. Further, one or more user responses associated with the campaign message may be received from one or more of the plurality of user devices (102, 202). Further, the one or more user responses may be transmitted to one or more agent device of a plurality of agent devices in real-time. The one or more agent devices may be selected based on a working status of each agent device. The working status may comprises at least one of an active status, an idle status, a busy status, and an offline status. Further, a direct communication may be enabled in real-time between the one or more agent devices and one or more user devices corresponding to the one or more user responses. The one or more user responses may be analyzed in real-time based on the campaign message and the historical data, using the training data model, to dynamically update the pacing rate for ongoing or future campaigns.

Further, the method (300) for campaign pacing may monitor one campaign and further tracks data associated the actual message sent, actual message delivered, user response, agents activity, traffic patterns, and conversations completion status in real-time. Further, the method (300) may compare the data against the predicted data by the AI technique and may update the parameters in real-time for an improved and smooth campaign process.

In one example, during a flash sale or a product launch by the marketer, approximately 200000 whatsapp messages may be paced over 36 hours such that peak replies time period may align with staffed hours. The product launch may be achieved by keeping 95% of target users under 10 sec queue time while clearing the list of target users in two days time period.

In another example, in financial services lead generation, an outreach may be staggered by a time-zone and agent-needed probability. Further, prioritizing users may likely to need real-time or live help and may reduce abandoned chats while holding daily throughput.

In yet another example, for appointment or slot booking, a throttle message may be send in micro-batched that may match real-time agent or slot availability. Further, the method (300) may prevent spikes that cause long queues at clinic/branch chat desks.

In yet another example, in high-touch onboarding or support, a longer, multi-turn use cases may be detected for lower pacing automatically, when the conversations of the longer, multi-turn use cases dominates the real-time load. Further, the longer, multi-turn use cases may corresponds to a KYC, and a plan changes.

The method (300) for campaign pacing system may coordinate when and how fast campaign messages are sent based on a predicted user response curves and a predicted or observed agent capacity. Further, the system (100) for campaign pacing may be utilized for quickly finishing campaigns without causing long user wait times and may be achieved with minimal integration to existing agent tools. Further, the system (100) may improve the quality of experience by protecting SLAs and campaign completion objective. In one embodiment, the SLAs may be <10 secs wait for 90% of users. Further, the system (100) may be data efficient due to the usage of historical campaigns and real-time signals. Further the system (100) may improve channel or vendor agnostic due to the usage of WhatsApp, SMS, other channels and heterogeneous agent tools.

Some embodiments of the present subject matter enable to provide a method to integrate a campaign pacing platform with an agent dashboard with minimal integration.

Some embodiments of the present subject matter enable to analyze a message feed associated with user-agent conversations using one of a Natural Language Processing (NLP) technique and a machine learning technique.

Some embodiments of the present subject matter enable to determine a set of agents getting overloaded based on delays in response times.

Some embodiments of the present subject matter enable to infer agent availability and modulate send-rate without deep, bespoke integrations such as a practical shim for pacing deployable quickly.

Some embodiments of the present subject matter enable to determine patterns regarding time lagged responses to campaigns.

Some embodiments of the present subject matter enable to determine a rate of messages to be sent to a plurality of users in a campaign based on analysis of real-time data and historical data using an artificial intelligence technique

Some embodiments of the present subject matter enable to tune a campaign response and an agent workload for a closed-loop optimization.

Some embodiments of the present subject matter enable to predict a number of messages to be sent to ensure best utilization of the agents without significant degradation in a user experience.

Some embodiments of the present subject matter enable to dynamically balance message distribution across multiple agents in real-time to minimize idle time and maximize campaign efficiency.

Some embodiments of the present subject matter enable to enable predictive allocation of agents to incoming user responses using machine learning models.

Some embodiments of the present subject matter enable to provide a flexible and modular pacing platform that can be easily integrated with third-party campaign management and customer relationship management (CRM) tools.

Some embodiments of the present subject matter enable to initiate a campaign using a pacing module.

Some embodiments of the present subject matter enable to determine a pacing rate of sending a campaign message to the plurality of users.

Some embodiments of the present subject matter enable to use an artificial intelligence model to analyze message data and historical data.

Some embodiments of the present subject matter enable to allocate an agent to each user from the plurality of users to provide proper assistance in a campaign process.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

Although implementations for a method and a system for campaign pacing have been described in language specific to structural features and/or methods, it is to be understood that the appended claims are not necessarily limited to the specific features described. Rather, the specific features are disclosed as examples of implementation for the method and the system for campaign pacing.

1. A method (300) for campaign pacing, the method (300) comprises:
receiving, by a processor (106), campaign data from a first device, wherein the campaign data comprises information associated with a plurality of target users and a campaign message associated with a product, and wherein the campaign message is further queued using a queue scheduling technique;
analyzing, by the processor (106), the campaign message using an artificial intelligence technique, wherein the artificial intelligence technique uses a training data model trained using historical data associated with multiple campaigns of multiple products;
determining, by the processor (106), a priority of the campaign message and a pacing rate of sending the campaign message based on the analysis of the campaign message; and
transmitting, by the processor (106), the campaign message to a plurality of user devices (102, 202) associated with the plurality of target users based on the determined pacing rate via a communication channel (204).

2. The method (300) as claimed in claim 1, wherein the historical data comprises a user behavior, an agent behavior, historical response data associated with the users, a historical response rate, and data associated with different campaign initiated in a defined time period.

3. The method (300) as claimed in claim 1, wherein the pacing rate is determined based on a number of agents available to assist the users and information associated with an average response times, a response quality, and resolution rates associated with each of a plurality of agents.

4. The method (300) as claimed in claim 1, wherein the priority of the campaign message is determined based on user engagement trends identified from the historical data.

5. The method (300) as claimed in claim 1, wherein the communication channel (204) is one of a Short Message Service (SMS), an email, a mobile application, and a web-based notification.

6. The method (300) as claimed in claim 1, further comprises:
receiving, by the processor (106), one or more user responses, associated with the campaign message, from one or more of the plurality of user devices (102, 202); and
transmitting, by the processor (106), the one or more user responses to one or more agent device of a plurality of agent devices in real-time, wherein the one or more agent devices are selected based on a working status of each agent device, and wherein the working status comprises at least one of an active status, an idle status, a busy status, and an offline status.

7. The method (300) as claimed in claim 1, further comprises enabling, by the processor (106), a direct communication, in real-time, between the one or more agent devices and one or more user devices corresponding to the one or more user responses.

8. The method (300) as claimed in claim 1, further comprises analyzing, by the processor (106), the one or more user responses, in real-time, based on the campaign message and the historical data, using the training data model, to dynamically update the pacing rate for ongoing or future campaigns.

9. A campaign pacing system (100), the system (100) comprising:
a memory (104); and
a processor (106) configured to execute the instructions stored in the memory (104), wherein the processor (106) configured to:
receive campaign data from a first device, wherein the campaign data comprises information associated with a plurality of target users and a campaign message associated with a product, and wherein the campaign message is further queued using a queue scheduling technique;
analyze the campaign message using an artificial intelligence technique, wherein the artificial intelligence technique uses a training data model trained using historical data associated with multiple campaigns of multiple products;
determine a priority of the campaign message and a pacing rate of sending the campaign message based on the analysis of the campaign message; and
transmit the campaign message to a plurality of user devices (102) associated with the plurality of target users based on the determined pacing rate via a communication channel (204).

10. The campaign pacing system (100) as claimed in claim 9, wherein the historical data comprises a user behavior, an agent behavior, historical response data associated with the users, a historical response rate, and data associated with different campaign initiated in a defined time period.

11. The campaign pacing system (100) as claimed in claim 9, wherein the pacing rate is determined based on a number of agents available to assist the users and information associated with an average response times, a response quality, and resolution rates associated with each of a plurality of agents.

12. The campaign pacing system (100) as claimed in claim 9, wherein the priority of the campaign message is determined based on user engagement trends identified from the historical data.

13. The campaign pacing system (100) as claimed in claim 9, further configured to:
receive one or more user responses, associated with the campaign message, from one or more of the plurality of user devices (102); and
transmit the one or more user responses to one or more agent device of a plurality of agent devices in real-time, wherein the one or more agent devices are selected based on a working status of each agent device, and wherein the working status comprises at least one of an active status, an idle status, a busy status, and an offline status.

14. The campaign pacing system (100) as claimed in claim 9, further configured to initiate a direct communication, in real-time, between the one or more agent devices and one or more user devices (102) corresponding to the one or more user responses.

15. The campaign pacing system (100) as claimed in claim 9, further configured to analyze the one or more user responses, in real-time, based on the campaign message and the historical data, using the training data model, to dynamically update the pacing rate for ongoing or future campaigns.

16. The campaign pacing system (100) as claimed in claim 9, further configured to:
receive the campaign data from a Communications Platform as a Service (CPaaS) provider module (206); and
transmit the campaign message to the communication channel (204) with minimal integration for campaign pacing.

17. A computer program product for campaign pacing, the computer program product comprising a non-transitory computer-readable storage medium having stored thereon instructions that are executed by one or more processors, wherein the one or more processors configured to:
receive campaign data from a first device, wherein the campaign data comprises information associated with a plurality of target users and a campaign message associated with a product, and wherein the campaign message is further queued using a queue scheduling technique;
analyze the campaign message using an artificial intelligence technique, wherein the artificial intelligence technique uses a training data model trained using historical data associated with multiple campaigns of multiple products;
determine a priority of the campaign message and a pacing rate of sending the campaign message based on the analysis of the campaign message; and
transmit the campaign message to a plurality of user devices (202) associated with the plurality of target users based on the determined pacing rate via a communication channel (204).
